(19) United States
(12) Patent Application Publication
(10) Pub. No.: US 2006/0075254 A1
(43) Pub. Date: Apr. 6, 2006

(54) Smart card functionality from a security co-processor and symmetric key in ROM

(75) Inventor: Mickey Ramal Henniger, Buchanan Dam, TX (US)

Correspondence Address: LAW OFFICE OF CHARLES E. KRUEGER, P.O. BOX 5607, WALNUT CREEK, CA, 94596-1607, US

(73) Assignee: CISCO TECHNOLOGY, INC. (A California Corporation)

(21) Appl. No.: 10/952,228

(22) Filed: Sep. 27, 2004

(51) Int. Cl. H04K 1/00

(52) U.S. Cl. 713/184

(57) ABSTRACT

Smart card functionality is implemented utilizing a security co-processor already included on a device and external memory. An internal private key is stored in NVROM on the die of the security co-processor and a private RAM, accessible by only the security co-processor, is also included. Blocks of data stored in external memory can be encrypted and decrypted using the private key. If other secret or symmetric keys are included in a block of data they are stored in clear text in the private RAM after decryption by the private internal key. The CPU can then request the security co-processor to encrypt/decrypt data using other secret or symmetric keys held in the private RAM.

### BACKGROUND OF THE INVENTION

Manufacturers of software and hardware products are developing methods for including tamper-proof product identification information and other secret information on products to detect, prevent, and or report the presence or use of unauthorized parts or products.

Smart cards are being used to store secret information that can be used to perform verification, secure communications, and authentication functions. The smart card is designed to prevent unauthorized access to the secret information that is stored in non-volatile memory on the smart card.

However, including a smart card in each unit of a hardware module could result in an unacceptable increase in the cost of production of the module. Additionally, the amount of memory available on a smart card is limited so that the amount of secret information that can be held is limited.

Accordingly, low cost techniques providing increased storage capacity are required for implementing smart card technology on hardware devices.

### BRIEF SUMMARY OF THE INVENTION

In a first embodiment of the invention, a security co-processor already included in a device is utilized to implement smart card functionality. An internal private key is stored on non-volatile ROM (NVROM) on the security co-processor die and used to encrypt smart card data which is stored as encrypted smart card data in external memory. A private RAM, accessible only by the security co-processor, is used to store a clear text image of the smart card data which is formed by decrypting the encrypted smart card data with the security co-processor using the internal, private key.

In another embodiment of the invention, a certificate including a device-specific serial number, device-specific public key, and digital signature of the device-specific serial number and device-specific public key by a trusted party is stored in the external memory by the manufacturer. A data string is encrypted by the security co-processor, using the internal, private key, to form an encrypted data string. The device-specific public key is then utilized to decrypt the encrypted data string to verify that the device-specific serial number has been assigned to the security co-processor which encrypted the data string.

In another embodiment of the invention, a manufacturer stores device identification and other information as an encrypted system block in non-modifiable external ROM. The encrypted system block is encrypted using the internal, private key.

In another embodiment of the invention, a secret key held in the system block, instead of the internal, private key, is used to encrypt the user block to guard against attacks on the internal, private key. The system block is decrypted by the security co-processor into clear text held in the private RAM. Thus, the CPU can request the security co-processor to encrypt/decrypt data using the secret key.

Other features and advantages of the invention will now be apparent in view of the following detailed description and appended figures.

### BRIEF DESCRIPTION OF THE DRAWINGS

FIG. 1 is a block diagram of a first embodiment of the invention having an encrypted user block in ROM;

FIG. 2 is a flow chart of a method for utilizing the embodiment of FIG. 1;

FIG. 3 is a block diagram of a second embodiment of the invention having a non-tamperable system block in ROM;

FIG. 4 is a flow chart of a method for utilizing the embodiment of FIG. 3; and

FIG. 5 is a block diagram of an embodiment including a microsequencer for sequencing through steps for authenticating a ROM Executive.

### DETAILED DESCRIPTION OF THE INVENTION

Reference will now be made in detail to various embodiments of the invention. Examples of these embodiments are illustrated in the accompanying drawings. While the invention will be described in conjunction with these embodiments, it will be understood that it is not intended to limit the invention to any embodiment. On the contrary, it is intended to cover alternatives, modifications, and equivalents as may be included within the spirit and scope of the invention as defined by the appended claims. In the following description, numerous specific details are set forth in order to provide a thorough understanding of the various embodiments. However, the present invention may be practiced without some or all of these specific details. In other instances, well known process operations have not been described in detail in order not to unnecessarily obscure the present invention.

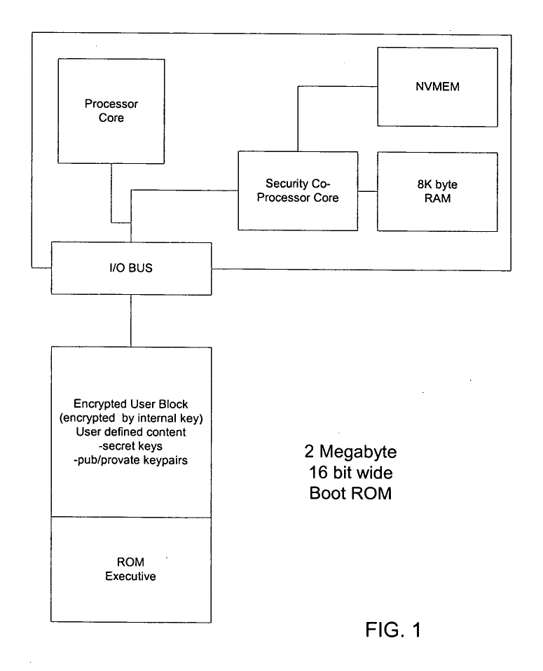

FIG. 1 is a block diagram of a first embodiment of the invention utilized to implement smart card functionality. A processor module, in the form of a single integrated circuit (IC), includes a processor core, I/O bus interface, security co-processor core, an NVROM holding a unique private, internal read-only symmetric encryption/decryption key, and a 8 K byte private RAM for the security co-processor core.

Alternatively, the smart card functionality can be implemented without the CPU core. For example, the security co-processor, internal ROM, and key could be implemented on a module separate from the CPU module and encrypted content stored in external Flash Memory or ROM.

Having the CPU and on same die as the security co-processor allows the CPU to confirm executable code before running it by accessing the security unit internally to confirm the executable code is not tampered prior to executing it.

The security co-processor core is a co-processor with an architecture designed to perform high speed encryption and decryption operations using a variety of algorithms. The private memory is accessible only by the security co-processor. For example, the access to the private RAM can require the use of virtual addresses instead of physical addresses.

Further, the secret key is stored in NVROM on the die itself and is only accessible to the security co-processor core. The secret key is never accessible outside the private memory area of the security co-processor core.

In this embodiment, the processor module is coupled to a 2 Megabyte, 16 byte wide boot ROM that includes an Encrypted User Block and a ROM Executive.

The contents of the Encrypted User Block may be changed by utilizing the security co-processor core to encrypt a new block of data encoded by the internal, private key on the module. In this case the ROM would be implemented as programmable ROM such as flash memory.

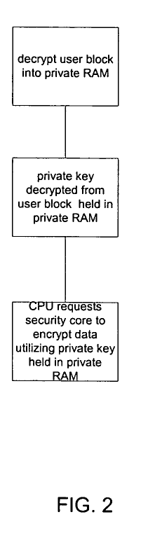

An example of the operation of the system to implement smart card functionality will now be described with reference to the flow chart of FIG. 2.

At initialization, ROM software asks the encryption core to decrypt the Encrypted User block into the private security co-processor core 8 K byte RAM memory. The 8 K byte RAM then contains the clear text versions of the secret/private credentials defined by the user and stored in the Encrypted User block. Only the encryption core has access to the private RAM and can see the clear text version.

The CPU can only ask the encryption core to perform functions based on the clear text information inside the 8 K byte RAM. For example, the CPU could request that an encrypted data block be decrypted by the security co-processor core utilizing a private key held in the private 8 K byte RAM.

When the security co-processor core is not being asked to do smart-card like functions (for entitlement, secure repository for secrets, or untamperable data storage) it can be reset and then asked to do normal hardware crypto functions such as bulk encryption of 3DES or AES.

The cost of implementing the smart card function of this embodiment is offset by the fact that crypto chips will be part of platforms shipping now and it is only a marginal cost addition to add the chip specific secret key.

The CPU can utilize the encryption core to perform functions such as digitally signing or encrypting/decrypting an external memory block using an encryption core private or secret key.

The above-described system has several advantages over the use of a standard smart card. In systems that utilize a processor module including a security co-processor core there is a very small incremental cost in implementing the system. Secondly, the secret information is stored externally, thus overcoming the small storage area limitation of the smart card because the external memory can be of any size desired.

Another security advantage of the system is that the internal, private key is never output from the encryption core private space and thus cannot be detected by snooping of external bus lines. Further, each internal, private key is unique to the processor module so that a successful attack on a single chip would not enable a “break once run everywhere” attack scenario. The expense necessary to attack a single chip would not be justified in most cases.

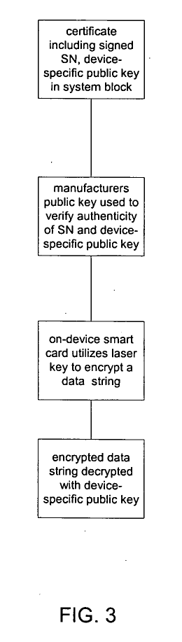

The system can also be utilized to provide a tamper proof identification (ID) to a part or module as depicted in the flow chart of FIG. 3. This is important in the case where licenses or other credentials are associated with a given product ID.

The manufacturer can store a certificate, including a serial number having a product ID identifying the type of product included, a device-specific public key being paired with the device-specific internal, private key stored in the encryption core of the device, and a digital signature of the serial number and the device-specific public key, in the ROM. The user can use a public key provided by the manufacturer to decode the digital signature to be assured that the device-specific public key and serial number were provided by the manufacturer and not altered.

However, it is still possible that the serial number is associated with another product. For example, the serial number could have been assigned to another board by an agent attempting to circumvent the protection provided for licenses or credentials associated with a given serial number.

However, the device specific public key associated with the serial number will defeat any attempt to assign the serial number to another device. The next step is to determine if this particular device includes a smart card which has the private key associated with the chip-specific public key. This is done by requesting that the smart chip on the device sign a random string with the smart chip's private key (the internal, private key). Finally, the signature generated by the smart chip on the device is checked using the device-specific public key. If it matches then this is the smart chip that has been assigned the serial number.

The device ID identifies the model type of device to which the serial number is assigned. If only the serial number were assigned and it did not include the product ID inside the serial number, then there would exist a way to create valid-looking smart chips for expensive boards by buying inexpensive modules, stealing the smart chip, and then discarding the remains of the inexpensive card. Then the smart chip could be placed on the expensive board and the expensive board would then have an authentic smart chip on it. However, this is prevented by digitally stamping the module type to the smart chip as well. That is why, in this embodiment, the serial number includes the module type.

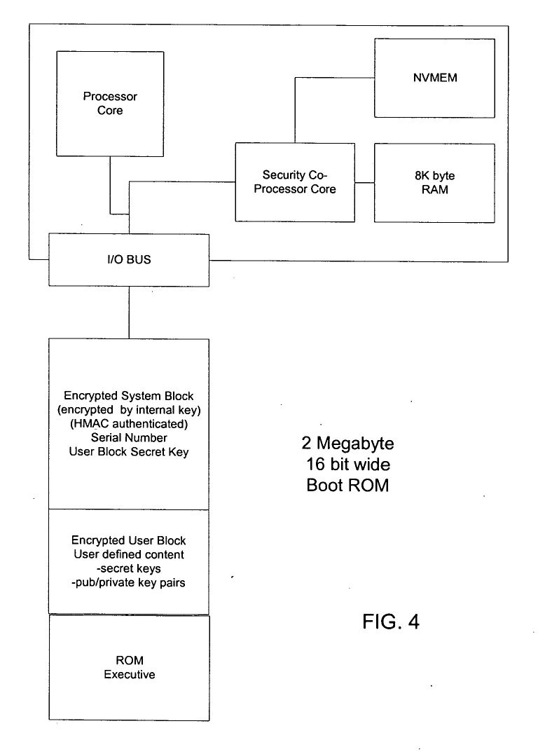

A second embodiment of the invention will now be described with reference to FIG. 4. The processor module is the same as depicted in FIG. 1. However, the contents and structure of the data stored in the boot ROM are different.

The addition of a non-modifiable Encrypted System Block including a serial number, having a product ID included, to the embodiment of FIG. 1 creates a component of information that, instead of being user defined, is defined by the manufacturer using the CPU/security co-processor core complex.

Since the end-user is not allowed to modify this component, then this component must be stored separately and protected in a way that prevents the end-user from destroying it. An authenticated write or a “write-once” function is required. The area written by the manufacturer is separated by the area written by the end user.

In this embodiment, the end-user definable block would be defined the same as it is with the smart card only approach with the user block being encrypted with a secret key held in the System Block instead of the internal, private key (this means attacks on the User Block's key does not compromise the System Block's protection.)

In this embodiment the solution is to provide a function in the CPU/security co-processor complex to create an Encrypted System Block using clear text external memory and the CPU's internal, private key. This is done in manufacturing, and the result is stored in Flash Memory.

Once the encrypted System Block is successfully stored in Flash Memory, the manufacturing process will then blow a fusable link that prevents the operation of creating a new Encrypted System Block. This prevents hackers from using the function to create what appears to be a legitimate Encrypted System Block.

The components of the System Block are not limited to the serial number but instead can be any data component where tamper resistance is desired. For example, a public key of a certificate authority or signer of other components in the system can be stored here.

An alternative to placing unchangeable components behind an encrypted/authenticated block is to place the untamperable component in internal, private but not publicly accessible internal memory. The lack of extensibility and assumed limitations on the number of bits available to be internal, private key makes this solution less desirable.

In this embodiment the decrypted serial number must be associated with the smart card because only the private key of the smart card can decrypt the encrypted serial number. Therefore, it is not necessary to challenge the smart card to encrypt a random number as required in the first embodiment.

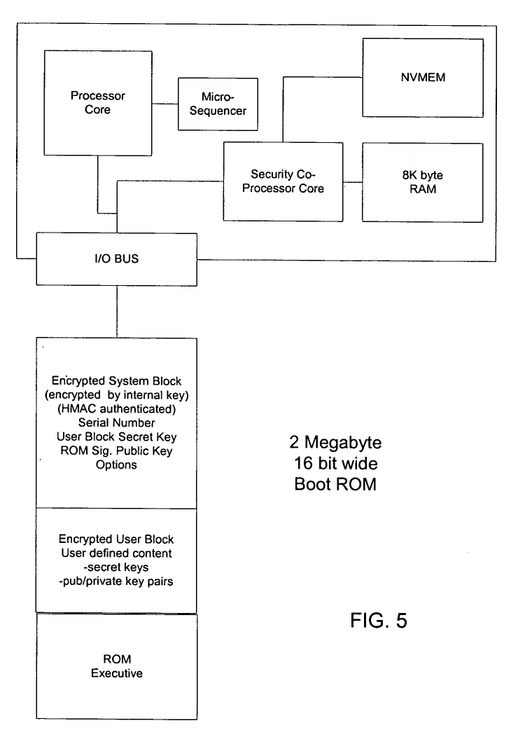

In a third embodiment, depicted in FIG. 5, once a tamper resistant block exists, it is possible to place a public key used to digitally sign the ROM Executive in this tamper resistant block. In this embodiment the CPU is stalled and a microsequencer uses the System Block to obtain the Public key used to sign the ROM, and check if the ROM is properly signed. If so, then execution of the ROM begins. In addition, once the System Block and ROM have been authenticated, the RESET/Pause to the processor can be removed, allowing it to begin execution of the ROM. Also, the System Block contains options that indicate if the JTAG port should be disabled, to prevent attacks via the JTAG port. In a preferred embodiment a microsequencer executes the following steps to authenticate the ROM Executive:
1. Decrypt the system block using the internal, private key into security co-processor core 8 K byte private, general purpose RAM
2. Confirm the HMAC (hash message authentication code) on the system block using the internal, private key.
3. Use the now decrypted ROM Public key to check the signature of the ROM to insure the ROM was indeed signed by the manufacturer.
4. Optionally the ROM can be copied into internal RAM and locked there (to minimize tampering).
5. If the options indicate that the JTAG port should be enabled, then enable them (only used by internal engineering.)
6. Unpause the CPU to allow execution of the ROM by the CPU.

The invention has now been described with reference to the preferred embodiments. Alternatives and substitutions will now be apparent to persons of skill in the art. Accordingly, it is not intended to limit the invention except as provided by the appended claims.

What is claimed is:

1. A method for implementing smart card functionality on a device having a security co-processor for performing encryption/decryption functions and having a private RAM on the CPU module accessible only by the security co-processor, said method comprising the steps of:
storing a device-specific, unique, symmetric, private key in on-module ROM accessible only by the security processor;
providing a user block of data to be encrypted, with the data including a user-provided encryption key; and
encrypting the user block with the device-specific private key and storing an encrypted user block in ROM external to the CPU module.

2. The method of claim 1 further comprising the steps of:
decrypting the encrypted user block with the security co-processor utilizing the device-specific, unique, symmetric, private key and storing a clear text version of the user block in the private RAM, with the clear text version of the user block including the user-provided symmetric key; and
performing a security function utilizing the user-provided symmetric key held in the private RAM.

3. The method of claim 2 where the step of performing a security function includes the steps of:
utilizing the user-provided key to digitally sign a block of data.

4. The method of claim 2 where the step of performing a security function includes the steps of:
utilizing the user-provided key to encrypt/decrypt a block of data.

5. The method of claim 1 further comprising the steps of:
storing a certificate in the external ROM including a device-specific serial number, a device-specific public key, and a digital signature of the device-specific serial number and public key signed by a trusted party;
utilizing a public key of the trusted party to verify that the device-specific serial number and public key were provided by the trusted party;
encrypting a data string with the security co-processor utilizing the device-specific private key to form an encrypted data string; and
decrypting the encrypted data string utilizing the device-specific public key to verify that the device-specific serial number is associated with CPU module.

6. The method of claim 5 further comprising the steps of:
including data identifying the type of device in the device-specific serial number.

7. The method of claim 1 further comprising:
including a CPU core on the device; and
utilizing the CPU core to confirm executable code prior to executing it.

8. A method for implementing smart card functionality on a device having a security co-processor for performing encryption/decryption functions and having a private RAM on the CPU module accessible only by the security co-processor, said method comprising the steps of:
storing a device-specific, unique, symmetric, private key in on-module ROM accessible only by the security processor;
providing a system block of data, with the data including a user-provided encryption key, to be encrypted;
encrypting the user block with the device-specific private key; and
storing an encrypted system block in non-modifiable ROM external to the CPU module.

9. The method of claim 8 where the step of storing the encrypted user block in non-modifiable ROM further comprises the steps of:
storing the encrypted user block in external flash memory; and
blowing a fusable link that prevents modification of data stored in the flash memory.

10. The method of claim 8 further comprising:
including a CPU core on the device; and
utilizing the CPU core to confirm executable code prior to executing it.

11. A system for implementing smart card functionality on a device having a security co-processor for performing encryption/decryption functions and having a private RAM on the CPU module accessible only by the security co-processor, said system comprising:
means for storing a device-specific, unique, symmetric, private key in on-module ROM accessible only by the security processor;
means for providing a user block of data to be encrypted, with the data including a user-provided encryption key; and
means for encrypting the user block with the device-specific private key and storing an encrypted user block in ROM external to the CPU module.

12. The system of claim 11 further comprising:
means for decrypting the encrypted user block with the security co-processor utilizing the device-specific, unique, symmetric, private key and storing a clear text version of the user block in the private RAM, with the clear text version of the user block including the user-provided symmetric key; and
means for performing a security function utilizing the user-provided symmetric key held in the private RAM.

13. The system of claim 12 where the means for performing a security function includes:
means for utilizing the user-provided key to digitally sign a block of data.

14. The system of claim 12 where the means for performing a security function includes:
means for utilizing the user-provided key to encrypt/decrypt a block of data.

15. The system of claim 11 further comprising:
means for storing a certificate in the external ROM including a device-specific serial number, a device-specific public key, and a digital signature of the device-specific serial number and public key signed by a trusted party;
means for utilizing a public key of the trusted party to verify that the device-specific serial number and public key were provided by the trusted party;
means for encrypting a data string with the security co-processor utilizing the device-specific private key to form an encrypted data string; and
means for decrypting the encrypted data string utilizing the device-specific public key to verify that the device-specific serial number is associated with CPU module.

16. The system of claim 15 further comprising:
means for including data identifying the type of device in the device-specific serial number.

17. The system of claim 11 further comprising:
a CPU core on the device; and
means for utilizing the CPU core to confirm executable code prior to executing it.

18. A system for implementing smart card functionality on a device module having a security co-processor for performing encryption/decryption functions and having a private RAM on the CPU module accessible only by the security co-processor, said system comprising:
means for storing a device-specific, unique, symmetric, private key in on-module ROM accessible only by the security processor;
means for providing a system block of data to be encrypted, with the data including a user-provided encryption key;
means for encrypting the user block with the device-specific private key; and
means for storing an encrypted system block in non-modifiable ROM external to the CPU module.

19. The system of claim 18 where the means for storing the encrypted use block in non-modifiable ROM further comprises:
means for storing the encrypted user block in external flash memory; and
means for blowing a fusable link that prevents modification of data stored in the flash memory.

20. The system of claim 18 further comprising:
a CPU core on the device; and
means for utilizing the CPU core to confirm executable code prior to executing it.

21. A computer program product for implementing smart card functionality on a device having a security co-processor, that executes the computer program product, on-module ROM accessible only by the security processor for storing a device-specific, unique, symmetric, private key, and a private RAM on the CPU module accessible only by the security co-processor, with the computer program product for performing encryption/decryption functions, said computer program product comprising:
a computer usable medium having computer readable program code physically embodied therein, said computer program product further comprising:
computer readable program code executed by the security co-processor for providing a user block of data to be encrypted, with the data including a user-provided encryption key; and
computer readable program code executed by the security co-processor for encrypting the user block with the device-specific private key and storing an encrypted user block in ROM external to the CPU module.

22. The computer program product of claim 21 further comprising:
computer readable program code executed by the security co-processor for decrypting the encrypted user block with the security co-processor utilizing the device-specific, unique, symmetric, private key and storing a clear text version of the user block in the private RAM, with the clear text version of the user block including the user-provided symmetric key; and
computer readable program code executed by the security co-processor for performing a security function utilizing the user-provided symmetric key held in the private RAM.

23. The computer program product of claim 22 where the computer readable program code executed by the security co-processor for performing a security function includes:
computer readable program code executed by the security co-processor for utilizing the user-provided key to digitally sign a block of data.

24. The computer program product of claim 22 where the computer readable program code executed by the security co-processor for performing a security function includes:
computer readable program code executed by the security co-processor for utilizing the user-provided key to encrypt/decrypt a block of data.

25. The computer program product of claim 21 further comprising:
computer readable program code executed by the security co-processor for storing a certificate in the external ROM including a device-specific serial number, a device-specific public key, and a digital signature of the device-specific serial number and public key signed by a trusted party;
computer readable program code executed by the security co-processor for utilizing a public key of the trusted party to verify that the device-specific serial number and public key were provided by the trusted party;
computer readable program code executed by the security co-processor for encrypting a data string with the security co-processor utilizing the device-specific private key to form an encrypted data string; and
computer readable program code executed by the security co-processor for decrypting the encrypted data string utilizing the device-specific public key to verify that the device-specific serial number is associated with CPU module.

26. The computer program product of claim 25 further comprising:
computer readable program code executed by the security co-processor for including data identifying the type of device in the device-specific serial number.

27. A computer program product for implementing smart card functionality on a device having a security co-processor, that executes the computer program product, on-module ROM accessible only by the security processor for storing a device-specific, unique, symmetric, private key, and a private RAM on the CPU module accessible only by the security co-processor, with the computer program product for performing encryption/decryption functions, said computer program product comprising:
a computer usable medium having computer readable program code physically embodied therein, said computer program product further comprising:
computer readable program code executed by the security co-processor for providing a system block of data to be encrypted, with the data including a user-provided encryption key;
computer readable program code executed by the security co-processor for encrypting the user block with the device-specific private key; and
computer readable program code executed by the security co-processor for storing an encrypted system block in non-modifiable ROM external to the CPU module.

28. A system for implementing smart card functionality on a device having a security co-processor for performing encryption/decryption functions and having a private RAM on the CPU module accessible only by the security co-processor, said system comprising:
on-device ROM storing a device-specific, unique, symmetric, private key accessible only by the security processor;
an external ROM, coupled to the device, holding a user block of data to be encrypted, with the data including a user-provided encryption key; and
with the security co-processor configured to encrypt the user block with the device-specific private key and storing an encrypted user block in ROM external to the CPU module.

29. The system of claim 28 further comprising:
a CPU core on the device

30. A system for implementing smart card functionality on a device having a security co-processor for performing encryption/decryption functions and having a private RAM on the CPU module accessible only by the security co-processor, said system comprising:
on-module ROM storing a device-specific, unique, symmetric, private key accessible only by the security processor;
an external ROM, coupled to the device, holding a user block of data to be encrypted, with the data including a user-provided encryption key;
a non-modifiable memory, coupled to the device, holding a system block holding system data encrypted by the manufacturer of the device, encrypted utilizing the device-specific, unique, symmetric, private key; and
with the security co-processor configured to encrypt the user block with the device-specific private key and storing an encrypted user block in ROM external to the CPU module.

31. The system of claim 30 further comprising:
a CPU core on the device
